(19) United States
(12) Patent Application Publication
(10) Pub. No.: US 2026/0303191 A1
(43) Pub. Date: Oct. 1, 2026

(54) METHOD AND APPARATUS OF DYNAMIC ADAPTION OF SPATIAL ELEMENTS

(71) Applicant: LENOVO (BEIJING) LIMITED, Beijing (CN)

(72) Inventors: Hongmei Liu, Beijing (CN); Yuantao Zhang, Beijing (CN); Zhi Yan, Beijing (CN); Yingying Li, Beijing (CN); Ran Yue, Beijing (CN); Haiming Wang, Beijing (CN)

(21) Appl. No.: 18/998,183

(22) PCT Filed: Jul. 27, 2022
(86) PCT No.: PCT/CN2022/108210

§ 371 Date: Jan. 24, 2025

(51) Int. Cl. H04B 7/06; H04L 5/00

(52) U.S. Cl. CPC H04B 7/06964; H04B 7/06968; H04L 5/0044; H04L 5/0092

(57) ABSTRACT

Embodiments of the present application are related to a method and apparatus of dynamic adaption of spatial elements. According an embodiment of the present application, an exemplary method includes: receiving information related to whether a node is on or off; and determining the at least one of the following in response to application of the information related to whether a node is on or off: at least one failure detection reference signal (RS) set for beam failure recovery, or at least one parameter associated with data transmission or data reception.

### TECHNICAL FIELD

Embodiments of the present application generally relate to wireless communication technology, especially to a method and apparatus of dynamic adaption of spatial elements.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems. However, wireless communication system still needs to evolve to pursue better service quality, better service experience and lower cost.

For example, regarding spatial elements in the wireless communication system, they generally include antenna element(s), transmission (Tx) radio unit(s) (RU)(s) (with sub-array/full-connection), antenna panel(s), transmit receive point (TRxP)((s) (also referred to as TRP, co-located or geographically separated from each other), and logical antenna port(s) (corresponding to specific signals and channels, also referred to as logic port(s) or antenna port(s)) etc. According to RAN1#109e agreement, it is needed to further study techniques and enhancements for the adaptation of spatial elements, which includes but not limited to the following aspects:
impact to user equipment (UE) operations from dynamic adaptation of spatial elements, e.g. measurements, channel state information (CSI) feedback, power control, physical uplink shared channel (PUSCH)/physical downlink shared channel (PDSCH) repetition, sounding reference signal (SRS) transmission, transmission configuration indication (TCI) configuration, beam management, beam failure recovery, radio link monitoring, cell (re)selection, handover, initial access, etc.;
signaling methods, including reduced signaling, for enabling dynamic spatial element adaptation;
   for example, group-common layer 1 (LI) signaling, broadcast signaling, media access control (MAC) control element (CE), etc.
dynamic logical port adaptation and efficient port reconfigurations
   study details of signaling the port (e.g. non-zero-power (NZP) CSI-reference signal (RS) ports) (if required to be known by the UE)
   study dynamic adaptation (including activation/deactivation) of CSI measurement or report configuration for port adaptation.

### SUMMARY OF THE DISCLOSURE

An objective of the present application is at least to provide a technical solution of dynamic adaption of spatial elements, e.g., a technical solution of performing beam failure recovery (BFR), data transmission and/or data reception etc. in response to dynamic adjustment of TRP's status.

Some embodiments of the present application provide an exemplary remote apparatus, e.g., a UE, which includes a transceiver and a processor coupled to the transceiver. The processor is configured to: receive, via the transceiver, information related to whether a node is on or off; and determine the at least one of the following in response to application of the information related to whether a node is on or off: at least one failure detection reference signal (RS) set for beam failure recovery, or at least one parameter associated with data transmission or data reception.

Some other embodiments of the present application also provide a method, which can be performed in a remote apparatus, e.g., a UE. The method includes: receiving information related to whether a node is on or off; and determining the at least one of the following in response to application of the information related to whether a node is on or off: at least one failure detection RS set for beam failure recovery, or at least one parameter associated with data transmission or data reception.

In some embodiments of the present application, the information related to whether a node is on or off is carried in group common downlink control information (DCI) or MAC CE.

In some embodiments of the present application, the information related to whether a node is on or off indicates at least one of the following: one or more node indexes; one or more control resource set (CORESET) pool indexes, each CORESET pool index corresponding to a node; or one or more TCI states, each TCI state corresponding to a node.

In some embodiments of the present application, in the case that there are a first failure detection RS set associated with a first node and a second failure detection RS set associated with a second node, determining at least one failure detection RS set for beam failure recovery in response to application of the information related to whether a node is on or off includes: maintaining the first failure detection RS set in response to the first node being on according to the information related to whether a node is on or off; discarding or suspending the first failure detection RS set in response to the first node being off according to the information related to whether a node is on or off; maintaining the second failure detection RS set in response to the second node being on according to the information related to whether a node is on or off; and discarding or suspending the second failure detection RS set in response to the second node being off according to the information related to whether a node is on or off.

In some embodiments of the present application, in the case that there is a failure detection RS set including a first subset of RSs associated with a first TCI state and a second subset of RSs associated with a second TCI state, determining at least one failure detection RS set for beam failure recovery in response to application of the information related to whether a node is on or off includes: maintaining the first subset of RSs in the failure detection RS set in response to a first node associated with the first TCI state being on according to the information related to whether a node is on or off; excluding the first subset of RSs from the failure detection RS set in response to the first node being off according to the information related to whether a node is on or off; maintaining the second subset of RSs in the failure detection RS set in response to a second node associated with the second TCI state being on according to the information related to whether a node is on or off; and excluding the second subset of RSs from the failure detection RS set in response to the second node being off according to the information related to whether a node is on or off.

In some embodiments of the present application, in the case that a CORESET with a lowest index of a plurality of configured CORESETs is associated with two TCI states, and each TCI state is associated with a node, determining at least one parameter associated with data transmission or data reception in response to application of the information related to whether a node is on or off includes: determining a pathloss RS for at least one of physical uplink control channel (PUCCH), physical uplink shared channel (PUSCH) or sounding reference signal (SRS) based on one TCI state associated with one node being on according to the information related to whether a node is on or off. In the case that two nodes associated with the two TCI states are on, the pathloss RS is determined based on a TCI state with a lower index of the two TCI states.

In some embodiments of the present application, in the case that quasi co-location (QCL) assumption for at least one of physical uplink control channel (PUCCH), PUSCH, physical downlink control channel (PDCCH), or PDSCH is determined based on a CORESET with a lowest index of a plurality of configured CORESETs associated with two TCI states, and each TCI state is associated with a node, determining at least one parameter associated with data transmission or data reception in response to application of the information related to whether a node is on or off includes: determining the QCL assumption for at least one of PUCCH, PUSCH, PDCCH, or PDSCH based on one TCI state associated with one node being on according to the information related to whether a node is on or off. In the case that two nodes associated with the two TCI states are on, the QCL assumption is determined based on a TCI state with a lower index of the two TCI states.

In some embodiments of the present application, in the case that QCL assumption for at least one of PDCCH or PDSCH is determined based on a CORESET associated with two activated TCI states, each TCI state associated with a node, determining at least one parameter associated with data transmission or data reception in response to application of the information related to whether a node is on or off includes: determining the QCL assumption for at least one of PDCCH or PDSCH based on at least one TCI state associated with at least one node being on according to the information related to whether a node is on or off.

In some embodiments of the present application, in the case that QCL assumption for PDSCH is based on a lowest codepoint among one or more TCI codepoints containing two TCI states, and each TCI state is associated with a node, determining at least one parameter associated with data transmission or data reception in response to application of the information related to whether a node is on or off includes: determining the QCL assumption for PDSCH based on at least one TCI state associated with at least one node being on according to the information related to whether a node is on or off.

In some embodiments of the present application, in the case that QCL assumption for PDSCH is based on a CORESET for reception associated with two TCI states, each TCI state associated with a node, determining at least one parameter associated with data transmission or data reception in response to application of the information related to whether a node is on or off includes: determining the QCL assumption for the PDSCH based on at least one TCI state associated with at least one node being on according to the information related to whether a node is on or off.

In some embodiments of the present application, in the case that QCL assumption for PDSCH is based on a codepoint indicating two TCI states, each TCI state associated with a node, determining at least one parameter associated with data transmission or data reception in response to application of the information related to whether a node is on or off includes: determining the QCL assumption for the PDSCH based on at least one TCI state associated with at least one node being on according to the information related to whether a node is on or off.

In some embodiments of the present application, whether a TCI state is activated for a CORESET is determined based on whether a node is on or off. In the case that there is more than one activated TCI state for a CORESET, sequence of the more than one activated TCI state is determined by sequence of TCI states excluding that associated with node being off. In some scenarios, the node is determined to be on or off by latest applied information related to whether a node is on or off. In some other scenarios, in the case that a node is indicated to be off after a TCI state associated with the node is activated for a CORESET by MAC CE, the node is determined to be off until the TCI state is activated again by another MAC CE.

In some embodiments of the present application, association between TCI states and nodes is configured by network side.

In some embodiments of the present application, in the case that there are two activated TCI states associated with two nodes, a first activated TCI state with a lower index of the two activated TCI states is associated with a first node with a lower index of the two nodes, and a second activated TCI state with a higher index of the two activated TCI states is associated with a second node with a higher index of the two nodes.

Some yet other embodiments of the present application also provide a RAN node, e.g., a gNB, which may include: a transceiver; and a processor coupled to the transceiver, wherein the processor is configured to: transmit, via the transceiver, information related to whether a node is on or off; and determine the at least one of the following in response to application of the information related to whether a node is on or off: at least one failure detection RS set for beam failure recovery, or at least one parameter associated with data transmission or data reception.

Given the above, embodiments of the present application provide a technical solution of dynamic adaption of spatial elements, e.g., determination of some default parameters for data transmission and/or data reception and BFR etc., in response to one or more nodes, e.g., TRPs being on or off dynamically, and thus will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary procedure of a method of dynamic adaption of spatial elements according to some embodiments of the present application.

FIG. 3 illustrates a block diagram of an exemplary apparatus of dynamic adaption of spatial elements according to some embodiments of the present application.

FIG. 4 illustrates a block diagram of an exemplary apparatus of dynamic adaption of spatial elements according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

A wireless communication system generally includes one or more base stations (BSs) and one or more UE. Furthermore, a BS may be configured with one TRP (or panel) or more TRPs (or panels). It should be understood that the TRP(s) (or panel(s)) configured for the BS may be transparent to a UE. A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g., on the order of tens of milliseconds, than that of the ideal backhaul link.

In a wireless communication system, a single TRP can be used to serve one or more UE under the control of a BS. In different scenarios, a TRP may be referred to as different terms. For example, a TRP can be identified by a TRP index, a CORESET pool index (e.g., a CORESETPoolIndex value) or a TCI state index etc. Again, persons skilled in the art should understand that as 3GPP and the communication technology develop, the terminologies recited in the specification may change, which should not affect the scope of the present application.

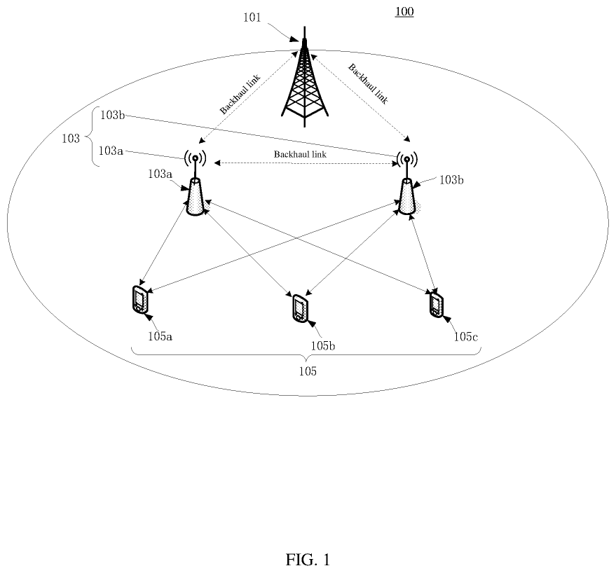

FIG. 1 is a schematic diagram illustrating an exemplary wireless communication system 100 according to some embodiments of the present application.

Referring to FIG. 1, a wireless communication system 100 can include a BS 101, TRPs 103 (e.g., a first TRP 103a and a second TRP 103b), and UEs 105 (e.g., a first UE 105a, a second UE 105b, and a third UE 105c). Although only one base station 101, two TRPs 103 and three UEs 105 are shown for simplicity, it should be noted that the wireless communication system 100 may include more or less communication device(s) or apparatus in accordance with some other embodiments of the present application.

In some embodiments of the present application, a BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The UEs 105 (for example, the first UE 105a, the second UE 105b, and the third UE 105c) may include, for example, but is not limited to, a computing device, a wearable device, a mobile device, an Internet of things (IoT) device, a vehicle, etc.

The TRPs 103, for example, the first TRP 103a and the second TRP 103b can communicate with the base station 101 via, for example, a backhaul link. Each of TRPs 103 can serve some or all of UEs 105. As shown in FIG. 1, the first TRP 103a can serve some mobile stations (which include the first UE 105a, the second UE 105b, and the third UE 105c) within a serving area or region (e.g., a cell or a cell sector). The second TRP 103b can serve some mobile stations (which include the first UE 105a, the second UE 105b, and the third UE 105c) within a serving area or region (e.g., a cell or a cell sector). The first TRP 103a and the second TRP 103b can communicate with each other via, for example, a backhaul link.

A multi-TRP transmission (or operation) may refer to at least two TRPs (or panels) to transmit data to a UE or receive date from UE. As shown in FIG. 1, for the same UE 105 (e.g., the first UE 105a, the second UE 105b, or the third UE 105c), two TRPs (e.g., the first TRP 103a and the second TRP 103b) may both transmit data to it or receive data from it, which is an exemplary scenario of multi-TRP transmission.

According to RAN1#109e agreement, there will be techniques and enhancements for adaptation of number of spatial elements of the gNB. For example, the status of a TRP may dynamically change between “on” and “off” for network energy saving, which will impact to UE operations, e.g., determination of pathloss RS for PUSCH, PUCCH and SRS power control, beam failure detection RS, PDSCH default beam, and PUSCH default beam etc. Regarding the terminology “beam,” it can be represented or identified in various manners, e.g., by spatial domain information, a TCI state, a RS or QCL assumption etc., and may evolve into other term(s) in the future. For example, a beam for downlink transmission can be represented by QCL assumption of a demodulation reference signal (DMRS) antenna port associated with PDCCH reception in a CORESET which is quasi co-located with a set of downlink RS.

At least considering the above study items, embodiments of the present application propose a technical solution of dynamic adaption of spatial elements, e.g., a method and apparatus of dynamic adaption of spatial elements, which mainly focuses on impact to UE operations caused by status changes of TRPs.

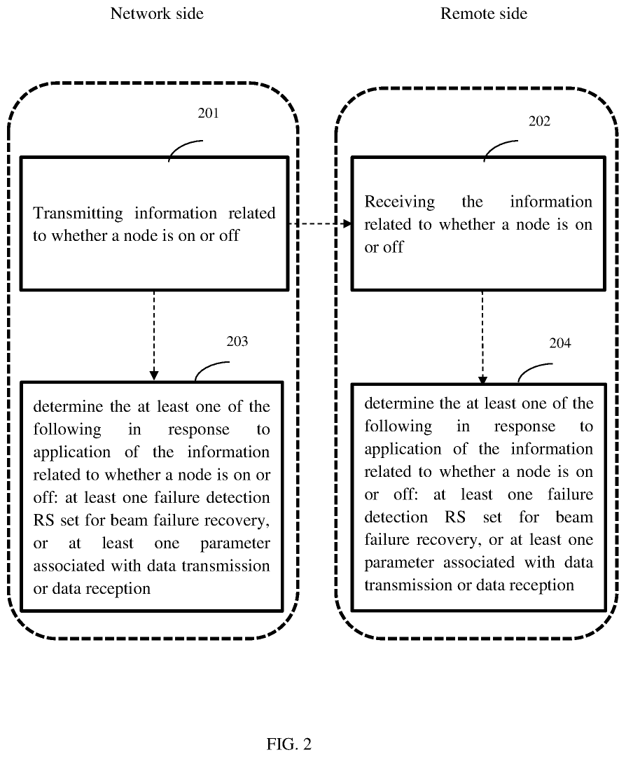

FIG. 2 is a flow chart illustrating an exemplary procedure of a method of dynamic adaption of spatial elements according to some embodiments of the present application. Although the method is illustrated in a system level between a RAN node, e.g., a gNB and a remote apparatus, e.g., a UE, persons skilled in the art should understand that the method implemented in the RAN node and the remote apparatus can be separately implemented and/or incorporated by other apparatus with the like functions.

Referring to FIG. 2, the network side, e.g., a gNB may dynamically turn a node, e.g., a TRP or the like on or off to save network power. A node can be a gNB, a TRP, a repeater, an IAB node, etc. Accordingly, in step 201, the network side will transmit information related to whether a node is on or off to the remote apparatus, e.g., a UE. Accordingly, the remote apparatus will receive the information related to whether a node is on or off in step 202.

The information related to whether a node is on or off can be transmitted or carried by various signaling, e.g., by a group common DCI or MAC CE etc. Meanwhile, the information related to whether a node is on or off can indicate one or more nodes on or off in various manners. For example, the information related to whether a node is on or off may indicate one or more node indexes, e.g., indicating two nodes being on by two node indexes represented by {0} and {1} or by {0, 1}. In another example, the information related to whether a node is on or off may indicate one or more CORESET pool indexes, each CORESET pool index corresponding to a node, e.g., indicating two nodes being off by two CORESET pool indexes represented by {0} and {1} or by {0,1}. In yet another example, the information related to whether a node is on or off may indicate one or more TCI states, each TCI state corresponding to a node, e.g., indicating two nodes being on by two TCI state indexes represented by {0} and {1} or by {0,1}.

The information related to whether a node is on or off may directly indicate the indicted nodes are on or off in some embodiments of the present application. In some other embodiments of the present application, the information related to whether a node is on or off may only indicate the associated node index, CORESET pool index or TCI state, and whether the indicated node is on or off can be further determined based on predefined rules or other configured information.

Regarding the association between TCI states and nodes, it can be configured by network side or can be predefined. For example, in the case that there are two activated TCI states associated with two nodes, a first activated TCI state with a lower index (or identifier) of the two activated TCI states is associated with a first node with a lower index (or identifier) of the two nodes, and a second activated TCI state with a higher index of the two activated TCI states is associated with a second node with a higher index of the two nodes. It is similar to the association between CORESET pool indexes and nodes.

In response to application of the information related to whether a node is on or off, the RAN node and remote apparatus will respectively determine the caused impact on operations. For example, the RAN node will determine the at least one of the following: at least one failure detection RS set for beam failure recovery, or at least one parameter associated with data transmission or data reception in step 203, and the remote apparatus will determine the at least one of the following: at least one failure detection RS set for beam failure recovery, or at least one parameter associated with data transmission or data reception in step 204.

Application time of the information related to whether a node is on or off can be configured by the network side, e.g., by a gNB or can be determined in the UE side based on a predefined rule(s). Exemplary application time is based on a time instance when the configured PDSCH and/or PUSCH before reception of the information related to whether a node is on or off is finished.

Details on the above operations will be further illustrated in view of various embodiments of the present application as follows. Persons skilled in the art should well know that considering the consistency between the network side and remote side, although some embodiments of the present application are illustrated mainly around the remote side, it is also adaptable for the network side.

Determination of failure detection RS set for beam failure recovery

In some scenarios of the present application, there are two failure detection RS sets (or two failure detection RS lists). For example, there are a first failure detection RS set associated with a first node and a second failure detection RS set associated with a second node. According to some embodiments of the present application, determining at least one failure detection RS set for beam failure recovery in response to application of the information related to whether a node is on or off may include: maintaining (or keeping) the first failure detection RS set in response to the first node being on according to the information related to whether a node is on or off; discarding or suspending the first failure detection RS set in response to the first node being off according to the information related to whether a node is on or off; maintaining the second failure detection RS set in response to the second node being on according to the information related to whether a node is on or off; and discarding or suspending the second failure detection RS set in response to the second node being off according to the information related to whether a node is on or off.

For example, a UE may be provided with two CORESETPoolIndex values, e.g., 0 and 1 and two failure detection RS sets, e.g., Set#1 and Set#2. Each CORESETPoolIndex value represents (or is associated with) a node. It is assumed that, CORESETPoolIndex value 0 represents a first node, and CORESETPoolIndex value 1 represents a second node. It is supposed that Set#1 is associated with CORESETPoolIndex value 0 (further associated with the first node) and Set#2 is associated with CORESETPoolIndex value 1 (further associated with the second node). In the case that there is no dynamic status change of node(s), Set#1 is determined based on the periodic CSI-RS resources with the same indexes as RS indexes in the RS sets indicated by TCI state for CORESETs associated with CORESETPoolIndex value 0, and Set#2 is determined based on the periodic CSI-RS resource index with the same indexes as RS indexes in the RS sets indicated by TCI state for CORESETs associated with CORESETPoolIndex value 1. In response to application of dynamic status changes of nodes, the UE will only maintain (or keep) the failure detection RS set whose associated node is set on. For example, in the case that the first node is indicated on and the second node is indicated off, then only Set#1 will be maintained while Set#2 will be discarded or suspended.

In some other scenarios of the present application, there is only one failure detection RS set. For example, there is a failure detection RS set including a first subset of RSs associated with a first TCI state and a second subset of RSs associated with a second TCI state. According to some embodiments of the present application, determining at least one failure detection RS set for beam failure recovery in response to application of the information related to whether a node is on or off may include: maintaining the first subset of RSs in the failure detection RS set in response to a first node associated with the first TCI state being on according to the information related to whether a node is on or off; excluding the first subset of RSs from the failure detection RS set in response to the first node being off according to the information related to whether a node is on or off; maintaining the second subset of RSs in the failure detection RS set in response to a second node associated with the second TCI state being on according to the information related to whether a node is on or off; and excluding the second subset of RSs from the failure detection RS set in response to the second node being off according to the information related to whether a node is on or off.

For example, a UE may be provided with a CORESET with two TCI states, wherein each TCI state is associated with (or represents) a node. It is assumed that, the first TCI state is associated with a first TRP and the second TCI state is associated with a second TRP. In addition, the UE may be provided with a sfnPDCCH set to sfnSchemeA or sfnSchemeB, and a failure detection resource set, e.g., Set#0 including RS indexes respectively associated with the two TCI states (respectively associated with the two TRPs). Accordingly, in response to application of dynamic status changes of TRP(s), the UE will only maintain (or keep) the RS index(es) whose associated TRP is set on in the failure detection RS set. For example, in the case that the first TRP is indicated off and the second TRP is indicated on, only RSs associated with the second TCI state (associated with the second TRP) will be maintained in Set#0, and other RSs in Set#0 will be discarded or suspended.

Determination of parameters associated with data transmission or data reception

Regarding parameters associated data transmission or data reception, from the perspective of the remote side, only power control parameter, e.g., pathloss RS for uplink transmission (e.g., PUCCH, PUSCH and SRS), and beams for downlink reception and uplink transmission are illustrated as examples. Consequently, from the perspective of the network side, only power control parameter, e.g., pathloss RS for uplink reception, and beams for downlink transmission and uplink reception are illustrated as examples. Persons skilled in the art can expect determining other parameters for data transmission or data reception similarly in response to application of dynamic status changes of node(s).

First, regarding pathloss RS, in some scenarios, a CORESET with a lowest index (or identifier) of a plurality of configured CORESETs is associated with two TCI states, and each TCI state is associated with a node. In response to application of the information related to whether a node is on or off, determining a pathloss RS for at least one of PUCCH, PUSCH or SRS may be based on one TCI state associated with one node being on according to the information related to whether a node is on or off. In the case that both the two nodes associated with the two TCI states are on, the pathloss RS is determined based on a TCI state with a lower index, e.g., the first TCI state of the two TCI states.

For example, in the case that the CORESET with the lowest index provided for a UE has one periodic RS resource configured with “typeD”, the pathloss RS is determined based on the periodic RS resource. In the case that the CORESET with the lowest index provided for a UE has two TCI states, the pathloss RS is determined based on the RS associated with the first TCI state, e.g., the TCI state with the lowest index. When there are two TCI states associated with different TRPs, in response to application of dynamic status changes of TRPs, the pathloss RS will be determined based on the RS associated with the TCI state whose associated TRP is set on. In the case that there is more than one TRP set on, e.g., two TRPs being on, the pathloss RS is determined based on the RS associated with the lower indexed TCI state whose associated TRP is set on. For example, it is supposed that there are two TRPS, e.g., TRP#1 and TRP#2, wherein the first TCI state associated with the CORESET with the lowest index is associated TRP#1, and the second TCI state associated with the CORESET with the lowest index is associated TRP#2. In the case that TRP#1 is off and TRP#2 is on, the pathloss RS is determined based on the second TCI state associated with TRP#2. In the case that both TRP#1 and TRP#2 are on, the pathloss RS is determined based on the first TCI state associated with TRP#1.

Regarding the beam determination for data transmission or data reception, there are more embodiments will be illustrated below.

In some scenarios of the present application, a beam e.g., QCL assumption for at least one of PUCCH, PUSCH, PDCCH, or PDSCH may be determined based on a CORESET with a lowest index of a plurality of configured CORESETs associated with two TCI states, and each TCI state is associated with a node. In response to application of the information related to whether a node is on or off, the beam, e.g., QCL assumption for at least one of PUCCH, PUSCH, PDCCH, or PDSCH is determined based on one TCI state associated with one node being on according to the information related to whether a node is on or off. In the case that two nodes associated with the two TCI states are on, the QCL assumption is determined based on a TCI state with a lower index of the two TCI states.

Taking PUCCH as an example, in the case that the CORESET with the lowest index configured for the UE has two TCI states respectively associated with two TRPs, a PUCCH default beam can be determined based on the RS associated with the first TCI state (e.g., the lower indexed one). In response to application of dynamic status changes of TRP(s), the PUCCH default beam will be determined based on the RS associated with a TCI state whose associated TRP is set on. For example, there are two TRPs, e.g., TRP#1 associated with the first TCI state and TRP#2 associated with the second TCI state. In the case that TRP#1 is on and TRP#2 is off, the PUCCH default beam is determined based on the RS associated with the first TCI state associated with TRP#1. In the case that TRP#1 is off and TRP#2 is on, the PUCCH default beam is determined based on the RS associated with the second TCI state associated with TRP#2. In the case that both TRP#1 and TRP#2 are on, the PUCCH default beam is determined based on the RS associated with the first TCI state associated with TRP#1.

Taking PUSCH scheduled by DCI 0 -0 as another example, in the case that the CORESET with the lowest index configured for the UE has two TCI states respectively associated with two TRPs, a PUSCH default beam can be determined based on the RS associated with the first TCI state (e.g., the lower indexes one). In response to application of dynamic status changes of TRP(s), the PUSCH default beam will be determined based on the RS associated with a TCI state whose associated TRP is set on. For example, there are two TRPs, e.g., TRP#1 associated with the first TCI state and TRP#2 associated with the second TCI state. In the case that TRP#1 is on and TRP#2 is off, the PUSCH default beam is determined based on the first TCI state associated with TRP#1. In the case that TRP#1 is off and TRP#2 is on, the PUSCH default beam is determined based on the second TCI state associated with TRP#2. In the case that both TRP#1 and TRP#2 are on, the PUSCH default beam is determined based on the first TCI state associated with TRP#1.

In some other scenarios of the present application, a beam, e.g., QCL assumption for at least one of PDCCH or PDSCH is determined based on a CORESET associated with two activated TCI states, wherein each TCI state is associated with a node. In response to application of the information related to whether a node is on or off, the beam, e.g., QCL assumption for at least one of PDCCH or PDSCH may be determined based on at least one TCI state associated with at least one node being on according to the information related to whether a node is on or off. In the case that the two nodes associated with the two TCI states are on, the QCL assumption will be determined based on both the two TCI states.

Taking PDSCH as an example, it is assumed that both sfnSchemePDCCH and sfnSchemePDSCH are configured for a UE. A PDSCH may be scheduled by DCI 1-0 for the UE, and there is no TCI field in DCI. Then, the UE will assume that the QCL assumption for PDSCH is identical to the TCI state associated with a CORESET for reception. The CORESET for reception will be activated with two TCI states. In response to application of dynamic status changes of TRPs, the PDSCH default beam will be determined based on the activated TCI state associated with a TRP(s) being on. For example, there are two TRPs, e.g., TRP#1 associated with the first activated TCI state and TRP#2 associated with the second activated TCI state. In the case that TRP#1 is on and TRP#2 is off, the PDSCH default beam is determined based on the first activated TCI state associated with TRP#1. In the case that TRP#1 is off and TRP#2 is on, the PDSCH default beam is determined based on the second activated TCI state associated with TRP#2. In the case that both TRP#1 and TRP#2 are on, the PDSCH default beam is determined based on both the first activated TCI state associated with TRP#1 and the second activated TCI state associated with TRP#2.

Taking PDCCH as an example, it is assumed that sfnSchemPDCCH set to sfnSchemeA is configured for a UE, the CORESET configured for the UE is activated with two TCI states, and PDCCH DMRS is QCLed with downlink RSs associated with the two activated TCI states. In response to application of dynamic status changes of TRP(s), the PDCCH default beam will be determined based on the CORESET associated with a TRP(s) being on. For example, there are two TRPs, e.g., TRP#1 associated with the first activated TCI state and TRP#2 associated with the second activated TCI state. In the case that TRP#1 is on and TRP#2 is off, the PDCCH default beam will be determined based on the RS associated with the first activated TCI state associated with TRP#1. In the case that TRP#1 is off and TRP#2 is on, the PDCCH default beam will be determined based on the RS associated with the second activated TCI state associated with TRP#2. In the case that both TRP#1 and TRP#2 are on, the PDCCH default beam will be determined based on the RS associated with both the first activated TCI state associated with TRP#1 and the second activated TCI state associated with TRP#2.

Still taking PDCCH as an example, it is assumed that sfnSchemPDCCH set to sfnSchemeB is configured for a UE, the CORESET configured for the UE is activated with two TCI states, and PDCCH DMRS (except for QCL parameter {Doppler shift, Doppler spread} of the second TCI state) is QCLed with downlink RSs associated with the two activated TCI states. In response to application of dynamic status changes of TRP(s), the PDCCH default beam will be based on the TCI state(s) associated with a TRP(s) being on. For example, there are two TRPs, e.g., TRP#1 associated with the first activated TCI state and TRP#2 associated with the second activated TCI state. In the case that TRP#1 is on and TRP#2 is off, the PDCCH default beam is determined based on the first activated TCI state associated with TRP#1. In the case that TRP#1 is off and TRP#2 is on, the PDCCH default beam is determined based on the second activated TCI state associated with TRP#2. In the case that both TRP#1 and TRP#2 are on, the PDCCH default beam is determined based on both the first activated TCI state associated with TRP#1 and the second activated TCI state associated with TRP#2 except that the doppler shift, doppler spread are based on the first activated TCI state associated with TRP#1.

In some yet other scenarios of the present application, a beam, e.g., QCL assumption for PDSCH is determined based on a lowest codepoint among one or more TCI codepoints containing two TCI states, and each TCI state is associated with a node. In response to application of the information related to whether a node is on or off, the beam, e.g., QCL assumption for PDSCH is determined based on at least one TCI state associated with at least one node being on according to the information related to whether a node is on or off. In the case that the two nodes associated with the two TCI states are on, the QCL assumption will be determined based on both the two TCI states.

For example, it is assumed that there are one or more TCI codepoints, each indicating (or containing) one or two TCI states (there may be other type TCI codepoint(s)). In response to application of dynamic status changes of TRPs, the PDSCH default beam (e.g., PDSCH and PDSCH DMRS ports) will be determined based on the TCI state(s) associated with the TRP(s) being on in the lowest codepoint among one or more TCI codepoints containing two TCI states. For example, there are two TRPs, e.g., TRP#1 associated with the first activated TCI state in the lowest codepoint and TRP#2 associated with the second activated TCI state in the lowest codepoint. In the case that TRP#1 is on and TRP#2 is off, the PDSCH default beam is determined based on the first TCI state associated with TRP#1 in the lowest indexed codepoint. In the case that TRP#1 is off and TRP#2 is on, the PDSCH default beam is determined based on the second TCI state in the lowest indexed codepoint associated with TRP#2. In the case that both TRP#1 and TRP#2 are on, the PDSCH default beam is determined based on both the first activated TCI state associated with TRP#1 and the second activated TCI state associated with TRP#2 in the lowest indexed codepoint.

In some yet other scenarios of the present application, a beam, e.g., QCL assumption for PDSCH is determined based on a CORESET for reception associated with two TCI states, wherein each TCI state is associated with a node. In response to application of the information related to whether a node is on or off, the beam, e.g., QCL assumption for the PDSCH is determined based on at least one TCI state associated with at least one node being on according to the information related to whether a node is on or off. In the case that the two nodes associated with the two TCI states are on, the QCL assumption will be determined based on both the two TCI states, e.g., the lowest indexed TCI state of the two TCI states.

For example, it is assumed that PDSCH is scheduled by DCI 1-0, 1-1, or 1-2, sfnSchemePDCCH is set to sfnSchemeA and sfnSchemePDSCH is not configured. In the case that no TCI codepoint with two TCI states is configured for PDSCH, and the CORESET scheduling PDSCH is indicated with two TCI states, the UE will assume that the TCI state for PDSCH is identical to the first TCI state applied for the CORESET. In response to application of dynamic status changes of TRP(s), the PDSCH default beam will be determined based on the TCI state associated with at least one node being on. For example, there are two TRPs, e.g., TRP#1 associated with the first TCI state associated with the CORESET scheduling PDSCH and TRP#2 associated with the second TCI state associated with the CORESET scheduling PDSCH. In the case that TRP#1 is on and TRP#2 is off, the PDSCH default beam is determined based on the first TCI state associated with TRP#1. In the case that TRP#1 is off and TRP#2 is on, the PDSCH default beam is determined based on the second TCI state associated with TRP#2. In the case that both TRP#1 and TRP#2 are on, the PDSCH default beam is determined based on the first activated TCI state associated with TRP#1.

In some yet other scenarios of the present application, a beam, e.g., QCL assumption for PDSCH is determined based on a codepoint indicating two TCI states, and each TCI state is associated with a node. In response to application of the information related to whether a node is on or off, the beam, e.g., QCL assumption for the PDSCH is determined based on at least one TCI state associated with at least one node being on according to the information related to whether a node is on or off. In the case that the two nodes associated with the two TCI states are on, the QCL assumption will be determined based on both the two TCI states.

For example, the UE is configured with sfnSchemePDSCH set to SfnschemeA, and is indicated with two TCI states in a codepoint of DCI field. The PDSCH DMRS will be determined to be QCLed with downlink RS(s) associated with the two TCI states. In the case that the UE does not support dynamic switching between one TCI state and two TCI states, the network side, e.g., the gNB cannot make proper scheduling based on the information related to whether a node is on or off. Considering that, in response to application of dynamic status changes of TRP(s), the PDSCH default beam will be based on the TCI state associated with at least one node being on. For example, there are two TRPs, e.g., TRP#1 associated with the first TCI state of the two TCI states and TRP#2 associated with the second TCI state of the two TCI states. In the case that TRP#1 is on and TRP#2 is off, the PDSCH default beam is determined based on the first TCI state associated with TRP#1. In the case that TRP#1 is off and TRP#2 is on, the PDSCH default beam is determined based on the second TCI state associated with TRP#2. In the case that both TRP#1 and TRP#2 are on, the PDSCH default beam is determined based on both the first activated TCI state associated with TRP#1 and the second activated TCI state associated with TRP#2.

In another example, the UE is configured with sfnSchemePDSCH set to SfnschemeB, and is indicated with two TCI states in a codepoint of DCI field. The PDSCH DMRS will be determined to be QCLed with downlink RS of the two TCI states in the codepoint except for QCL parameters {Doppler shift} and {Doppler spread} of the second TCI state. Similarly, in the case that the UE does not support dynamic switching between one TCI state and two TCI states, the network side, e.g., the gNB cannot make proper scheduling based on the information related to whether a node is on or off. Considering that, in response to application of dynamic status changes of TRP(s), the PDSCH default beam will be determined based on the TCI state associated with at least one node being on in the codepoint. For example, there are two TRPs, e.g., TRP#1 associated with the first TCI state and TRP#2 associated with the second TCI state. In the case that TRP#1 is on and TRP#2 is off, the PDSCH default beam is determined based on the first TCI state associated with TRP#1 in the codepoint. In the case that TRP#1 is off and TRP#2 is on, the PDSCH default beam is determined based on the second TCI state associated with TRP#2 in the codepoint. In the case that both TRP#1 and TRP#2 are on, the PDSCH default beam is determined based on both the first activated TCI state associated with TRP#1 and the second activated TCI state associated with TRP#2 except for QCL parameters {Doppler shift} and {Doppler spread} of the second TCI state.

Although the above embodiments are illustrated in view of at most two nodes (two TCI states or CORESET pool indexes etc.), persons killed in the art can well know that the illustrated solution can also applied to more nodes (more TCI states or CORESET pool indexes) in similar manners.

In some embodiments of the present application, whether a TCI state is activated for a CORESET is determined based on whether a node is on or off. In the case that there is more than one activated TCI state for a CORESET, sequence of the more than one activated TCI state is determined by sequence of TCI states excluding that associated with node being off. For example, if the CORESET is firstly activated with two TCI states and the first TCI state is indicated to be off, then the CORESET's first activated TCI state will be the previous second TCI state. In another example, if the CORESET is firstly activated with two TCI states, and the second TCI state is indicated to be off, then the CORESET's first activated TCI state will be the previous first TCI state. In yet another example, if the CORESET is firstly activated with two TCI states and both the first and the second TCI states are indicated to be on, then the CORESET's first activated TCI state will be the previous first TCI state and the CORESET's second activated TCI state will be the previous second TCI state. In yet another example, if the CORESET is firstly activated with two TCI states, and both the first and the second TCI states are indicated to be off, then the UE can skip PDCCH reception associated with the CORESET. In the case that there is only one first activated TCI state for a CORESET and the associated TRP is off, then the UE reception of PDCCH of the CORESET will be skipped.

Regarding how to determine whether a TCI state is activated for a CORESET based on the information related to whether a node is on or off, there are various manners.

For example, according to some embodiments of the present application, the node is determined to be on or off by the latest applied information related to whether a node is on or off. The status of a TCI state is determined by the node being on or off, and no matter status change of the TCI state between activated (on) or deactivated (off). If a TCI state for a CORESET is firstly activated by the MAC CE and the TRP associated with the TCI state is set on, then the TCI state for the CORESET will be considered as activated. If a TCI state for a CORESET is firstly activated by the MAC CE and the TRP associated with the TCI state is set off and then the TCI state is set on, then the TCI state for the CORESET will be considered as activated. If a TCI state for a CORESET is firstly activated by the MAC CE and the TRP associated with the TCI state is set off, then the TCI state for the CORESET will be considered as deactivated. If a TCI state for a CORESET is firstly activated by the MAC CE and the TRP associated with the TCI state is set on and then the TCI state is set off, then the TCI state for the CORESET will be considered as deactivated.

According to some other embodiments of the present application, in the case that a node is indicated to be off after a TCI state associated with the node is activated for a CORESET by MAC CE, the node is determined to be off until the TCI state is activated again by another MAC CE. If a TCI state is changed from on to off, even there is a signaling changing the TCI state from off to on, it will be not be considered activated before application of a new MAC CE signaling indicating the TCI state to be activated. If a TCI state for a CORESET is firstly activated by the MAC CE and the TRP associated with the TCI state is not set to be off, and there is no new MAC CE signaling changing the state of the TCI state, ; then the TCI state for the CORESET will be considered as activated. If a TCI state for a CORESET is firstly activated by the MAC CE and the TRP associated with the TCI state is set to be off, and there is a new MAC CE signaling indicating activating the TCI state; then the TCI state for the CORESET will not be considered as activated.

Besides the methods, embodiments of the present application also propose an apparatus of dynamic adaption of spatial elements.

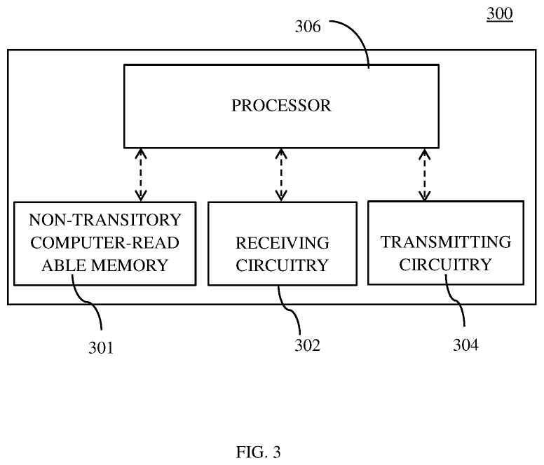

For example, FIG. 3 illustrates a block diagram of an apparatus of dynamic adaption of spatial elements 300 according to some embodiments of the present application.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The at least one processor 306 may be a CPU, a DSP, a microprocessor etc. The apparatus 300 may be a RAN node, e.g., a gNB or a remote apparatus, e.g., a UE configured to perform a method illustrated in the above or the like.

Although in this figure, elements such as the at least one processor 306, transmitting circuitry 304, and receiving circuitry 302 are described in the singular, the plural is contemplated unless a limitation to the singular is explicitly stated. In some embodiments of the present application, the receiving circuitry 302 and the transmitting circuitry 304 can be combined into a single device, such as a transceiver. In certain embodiments of the present application, the apparatus 300 may further include an input device, a memory, and/or other components.

In some embodiments of the present application, the non-transitory computer-readable medium 301 may have stored thereon computer-executable instructions to cause a processor to implement the method with respect to the RAN node, e.g., the gNB as described above. For example, the computer-executable instructions, when executed, cause the processor 306 interacting with receiving circuitry 302 and transmitting circuitry 304, so as to perform the steps with respect to the RAN node as depicted above.

In some embodiments of the present application, the non-transitory computer-readable medium 301 may have stored thereon computer-executable instructions to cause a processor to implement the method with respect to the remote apparatus, e.g., the UE as described above. For example, the computer-executable instructions, when executed, cause the processor 306 interacting with receiving circuitry 302 and transmitting circuitry 304, so as to perform the steps with respect to the remote apparatus as illustrated above.

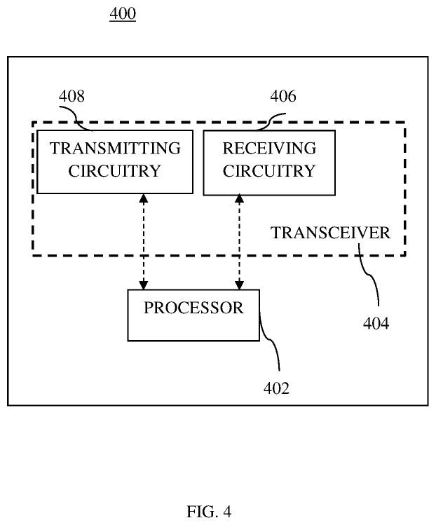

FIG. 4 is a block diagram of an apparatus of dynamic adaption of spatial elements 400 according to some other embodiments of the present application.

Referring to FIG. 4, the apparatus 400, for example a gNB or a UE may include at least one processor 402 and at least one transceiver 404 coupled to the at least one processor 402. The transceiver 404 may include at least one separate receiving circuitry 406 and transmitting circuitry 404, or at least one integrated receiving circuitry 406 and transmitting circuitry 404. The at least one processor 402 may be a CPU, a DSP, a microprocessor etc.

According to some embodiments of the present application, the apparatus 400 is a RAN node, e.g., a gNB, which includes: a transceiver; and a processor coupled to the transceiver, wherein the processor is configured to: transmit, via the transceiver, information related to whether a node is on or off; and determine the at least one of the following in response to application of the information related to whether a node is on or off: at least one failure detection RS set for beam failure recovery, or at least one parameter associated with data transmission or data reception.

According to some embodiments of the present application, the apparatus 400 is a remote apparatus, e.g., a UE, which includes: a transceiver; and a processor coupled to the transceiver, wherein the processor is configured to: receive, via the transceiver, information related to whether a node is on or off; and determine the at least one of the following in response to application of the information related to whether a node is on or off: at least one failure detection RS set for beam failure recovery, or at least one parameter associated with data transmission or data reception.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory; and
at least one processor coupled with the at least one memory and configured to cause the UE to:
receive information related to whether a node is on or off; and
determine the at least one of the following in response to application of the information related to whether a node is on or off: at least one failure detection reference signal (RS) set for beam failure recovery, or at least one parameter associated with data transmission or data reception.

2. The UE of claim 1, wherein, the information related to whether a node is on or off indicates at least one of the following:
one or more node indexes;
one or more control resource set (CORESET) pool indexes, each CORESET pool index corresponding to a node; or
one or more transmission configuration indication (TCI) states, each TCI state corresponding to a node.

3. The UE of claim 1, wherein, there are a first failure detection RS set associated with a first node and a second failure detection RS set associated with a second node, determining at least one failure detection Re set for beam failure recovery in response to application of the information related to whether a node is on or off comprises:
maintaining the first failure detection RS set in response to the first node being on according to the information related to whether a node is on or off;
discarding or suspending the first failure detection RS set in response to the first node being off according to the information related to whether a node is on or off;
maintaining the second failure detection RS set in response to the second node being on according to the information related to whether a node is on or off; and
discarding or suspending the second failure detection RS set in response to the second node being off according to the information related to whether a node is on or off.

4. The UE of claim 1, wherein, if there is a failure detection RS set including a first subset of RSs associated with a first transmission configuration indication (TCI) state and a second subset of RSs associated with a second TCI state, determining at least one failure detection RS set for beam failure recovery in response to application of the information related to whether a node is on or off comprises:
maintaining the first subset of RSs in the failure detection RS set in response to a first node associated with the first TCI state being on according to the information related to whether a node is on or off;
excluding the first subset of RSs from the failure detection RS set in response to the first node being off according to the information related to whether a node is on or off;
maintaining the second subset of RSs in the failure detection RS set in response to a second node associated with the second TCI state being on according to the information related to whether a node is on or off; and
excluding the second subset of RSs from the failure detection RS set in response to the second node being off according to the information related to whether a node is on or off.

5. The UE of claim 1, wherein, if a control resource set (CORESET) with a lowest index of a plurality of configured CORESETs is associated with two transmission configuration indication (TCI) states, and each TCI state is associated with a node, determining at least one parameter associated with data transmission or data reception in response to application of the information related to whether a node is on or off comprises:
determining a pathloss RS for at least one of physical uplink control channel (PUCCH), physical uplink shared channel (PUSCH) or sounding reference signal (SRS) based on one TCI state associated with one node being on according to the information related to whether a node is on or off.

6. The UE of claim 1, wherein, if quasi co-location (QCL) assumption for at least one of physical uplink control channel (PUCCH), physical uplink shared channel (PUSCH), physical downlink control channel (PDCCH), or physical downlink shared channel (PDSCH) is determined based on a control resource set (CORESET) with a lowest index of a plurality of configured CORESETs associated with two transmission configuration indication (TCI) states, and each TCI state is associated with a node, determining at least one parameter associated with data transmission or data reception in response to application of the information related to whether a node is on or off comprises:
determining the QCL assumption for at least one of PUCCH, PUSCH, PDCCH, or PDSCH based on one TCI state associated with one node being on according to the information related to whether a node is on or off.

7. The UE of claim 1, wherein, if quasi co-location (QCL) assumption for at least one of physical downlink control channel (PDCCH) or physical downlink shared channel (PDSCH) is determined based on a control resource set (CORESET) associated with two activated transmission configuration indication (TCI) states, each TCI state associated with a node, determining at least one parameter associated with data transmission or data reception in response to application of the information related to whether a node is on or off comprises:
determining the QCL assumption for at least one of PDCCH or PDSCH based on at least one TCI state associated with at least one node being on according to the information related to whether a node is on or off.

8. The UE of claim 1, wherein, if quasi co-location (QCL) assumption for physical downlink shared channel (PDSCH) is based on a lowest codepoint among one or more transmission configuration indication (TCI) codepoints containing two TCI states, each TCI state associated with a node, determining at least one parameter associated with data transmission or data reception in response to application of the information related to whether a node is on or off comprises:
determining the QCL assumption for PDSCH based on at least one TCI state associated with at least one node being on according to the information related to whether a node is on or off.

9. The UE of claim 1, wherein, if quasi co-location (QCL) assumption for physical downlink shared channel (PDSCH) is based on a control resource set (CORESET) for reception associated with two transmission configuration indication (TCI) states, each TCI state associated with a node, determining at least one parameter associated with data transmission or data reception in response to application of the information related to whether a node is on or off comprises:
determining the QCL assumption for the PDSCH based on at least one TCI state associated with at least one node being on according to the information related to whether a node is on or off.

10. The UE of claim 1, wherein, if quasi co-location (QCL) assumption for physical downlink shared channel (PDSCH) is based on a codepoint indicating two transmission configuration indication (TCI) states, each TCI state associated with a node, determining at least one parameter associated with data transmission or data reception in response to application of the information related to whether a node is on or off comprises:
determining the QCL assumption for the PDSCH based on at least one TCI state associated with at least one node being on according to the information related to whether a node is on or off.

11. The remote apparatus UE of claim 1, wherein, whether a transmission configuration indication (TCI) state is activated for a control resource set (CORESET) is determined based on whether a node is on or off.

12. The UE of claim 11, wherein, if a node is indicated to be off after a transmission configuration indication (TCI) state associated with the node is activated for a control resource set (CORESET) by media access control (MAC) control element (CE), the node is determined to be off until the TCI state is activated again by another MAC CE.

13. The remote apparatus UE of claim 1, wherein, association between transmission configuration indication (TCI) states and nodes is configured by network side.

14. A radio access network (RAN) node, comprising:
a transceiver; and
a processor coupled to the transceiver, wherein the processor is configured to:
at least one memory; and
at least one processor coupled with the at least one memory and configured to cause the RAN to:
transmit information related to whether a node is on or off; and
determine the at least one of the following in response to application of the information related to whether a node is on or off: at least one failure detection reference signal (RS) set for beam failure recovery, or at least one parameter associated with data transmission or data reception.

15. A method performed by a user equipment (UE), the method comprising:
receiving information related to whether a node is on or off; and
determining the at least one of the following in response to application of the information related to whether a node is on or off: at least one failure detection reference signal (RS) set for beam failure recovery, or at least one parameter associated with data transmission or data reception.

16. A processor for wireless communication, comprising:
at least one controller coupled with at least one memory and configured to cause the processor to:
receive information related to whether a node is on or off; and
determine the at least one of the following in response to application of the information related to whether a node is on or off: at least one failure detection reference signal (RS) set for beam failure recovery, or at least one parameter associated with data transmission or data reception.

17. The processor of claim 16, wherein, the information related to whether a node is on or off indicates at least one of the following:
one or more node indexes;
one or more control resource set (CORESET) pool indexes, each CORESET pool index corresponding to a node; or
one or more transmission configuration indication (TCI) states, each TCI state corresponding to a node.

18. The processor of claim 16, wherein, if there are a first failure detection RS set associated with a first node and a second failure detection RS set associated with a second node, determining at least one failure detection RS set for beam failure recovery in response to application of the information related to whether a node is on or off comprises:
maintaining the first failure detection RS set in response to the first node being on according to the information related to whether a node is on or off;
discarding or suspending the first failure detection RS set in response to the first node being off according to the information related to whether a node is on or off,
maintaining the second failure detection RS set in response to the second node being on according to the information related to whether a node is on or off; and
discarding or suspending the second failure detection RS set in response to the second node being off according to the information related to whether a node is on or off.

19. The processor of claim 16, wherein, if there is a failure detection RS set including a first subset of RSs associated with a first transmission configuration indication (TCI) state and a second subset of RSs associated with a second TCI state, determining at least one failure detection RS set for beam failure recovery in response to application of the information related to whether a node is on or off comprises:
maintaining the first subset of RSs in the failure detection RS set in response to a first node associated with the first TCI state being on according to the information related to whether a node is on or off;
excluding the first subset of RSs from the failure detection RS set in response to the first node being off according to the information related to whether a node is on or off;
maintaining the second subset of RSs in the failure detection RS set in response to a second node associated with the second TCI state being on according to the information related to whether a node is on or off; and
excluding the second subset of RSs from the failure detection RS set in response to the second node being off according to the information related to whether a node is on or off.

20. The processor of claim 16, wherein, if a control resource set (CORESET) with a lowest index of a plurality of configured CORESETs is associated with two transmission configuration indication (TCI) states, and each TCI state is associated with a node, determining at least one parameter associated with data transmission or data reception in response to application of the information related to whether a node is on or off comprises:
determining a pathloss RS for at least one of physical uplink control channel (PUCCH), physical uplink shared channel (PUSCH) or sounding reference signal (SRS) based on one TCI state associated with one node being on according to the information related to whether a node is on or off.
